(19) United States
(12) Patent Application Publication
(10) Pub. No.: US 2013/0248008 A1
(43) Pub. Date: Sep. 26, 2013

(54) RAMP ASSEMBLY FOR THE EMPTYING OF A LEG BAG

(71) Applicant: THE BATHROOM GEM, L.L.C., West Des Moines, IA (US)

(72) Inventor: James W. Thomas, West Des Moines, IA (US)

(73) Assignee: THE BATHROOM GEM, L.L.C., West Des Moines, IA (US)

(21) Appl. No.: 13/847,664

(22) Filed: Mar. 20, 2013

Related U.S. Application Data
(60) Provisional application No. 61/613,700, filed on Mar. 21, 2012.

(51) Int. Cl. A61J 1/14

(52) U.S. Cl. CPC A61J 1/14
USPC 137/234.6

(57) ABSTRACT

A ramp assembly having a support body with a ramp surface. The ramp surface has a drain plate that covers an opening that receives a drain pan.

### CROSS REFERENCE TO RELATED APPLICATION

This application claims the benefit of U.S. Provisional Application No. 61/613,700 filed Mar. 21, 2012.

### BACKGROUND OF THE INVENTION

This invention relates to a ramp assembly. More specifically this invention relates to a ramp assembly that allows an individual to release the contents of a leg bag into the assembly.

Conventionally, a patient that is bound to a wheel chair wears a leg bag that collects fluid. When this leg bag fills then a nurse, orderly, or assistance provider is required to help the patient empty the leg bag. This process is labor intensive, expensive, and requires the presence of another person who is often a paid assistance provider.

To improve upon this manual and labor intensive process, electric and mechanically powered release systems were developed that can be controlled by the operator of the wheel chair without further assistance. Still, disposing of the fluid in the leg bag is problematic. Thus, a need in the art exists for an assembly that facilitates the emptying of a leg bag.

### SUMMARY OF THE INVENTION

A ramp assembly having a support body with a first end that is lower than a second end to form a ramp surface. The ramp surface has an opening that receives a drain pan. To cover the opening, a drain plate having a plurality of slots is fitted to cover the opening.

### BRIEF DESCRIPTION OF THE DRAWINGS

FIG. 1 is a perspective view of a ramp assembly; and

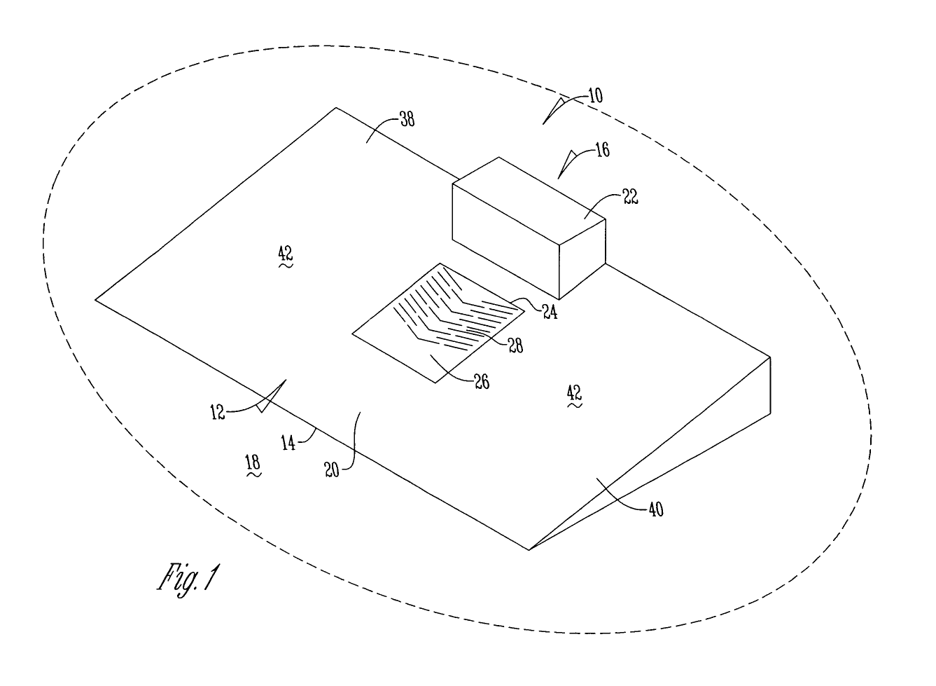

FIG. 2 is a side sectional view of a ramp assembly.

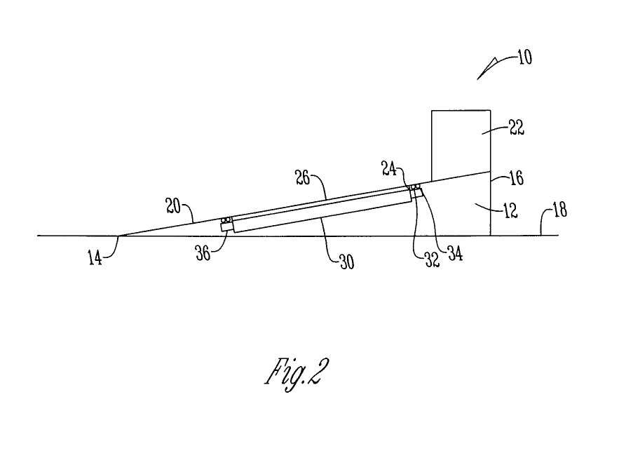

### DESCRIPTION OF THE PREFERRED EMBODIMENTS

The figures show a ramp assembly 10 that has a support structure or body 12 having a first end 14 with a greater height than a second end 16 that is adjacent the floor 18 to provide an angled ramp surface 20 that is supported and represents a ramp. A stop member 22 is secured to the support body 12 and in one embodiment is considered a control box.

An opening 24 is disposed within the ramp surface 20 of the support structure 12 and is covered by a removable drain cover 26 that has a plurality of slots and openings 28 therein to allow the passage of fluid. Disposed underneath the opening 24 is a drain pan 30 that is connected to the support structure 12 underneath the opening 24 with a support ring 32 and mounting ring 34 to hold the pan 30 in place. The pan 30 additionally has a tube elbow fitting 36 that can be utilized to convey fluid from the pan 30.

In one embodiment first extension 38 and second extension 40 sections may be placed and secured to the support body 12. Together the support structure 12 and the extension sections 38, 40 present identically sloping ramp support surfaces 42 that matingly engage the support body 12 to form one single smooth surface.

In operation when an individual needs to release the fluid from their leg bag the individual moves the front wheels of their wheelchair up the ramp surface 20 of the support body 12 until the tube of their leg bag is directly over the drain plate 26 of the opening 29 of the support body 12. At this time their leg bag can be actuated either electrically or mechanically depending upon the type of leg bag utilized so that the fluid within the bag may flow through the slots 28 and openings 29 within the drain plate 26 and into the pan 30. The fluid can then be conveyed through tube elbow fitting 36 to a desired location. When cleaning the assembly one only need to clean the drain plate 26 and remove the drain plate 26 to clean the pan 30 in order to keep the assembly sanitary.

Thus presented is a ramp assembly that allows an individual in a wheel chair to empty their leg bag into a pan. By presenting a ramp surface the angle of the fluid flowing from the tube from the leg bag is improved to ensure that spillage is minimized. Further, by using the control box and the first and second attachment members provides better control and easier use for the individual in the wheelchair. In addition, because of the design the assembly may be easily cleaned providing improved sanitation. Further, by utilization of the assembly with a leg bag that allows self-use by the individual in the wheelchair the individual has more freedom and ability to help them without the need of additional assistance. Thus, all of the stated problems and needs described in the Background have been overcome and met.

I claim:

1. A ramp assembly for the emptying of a leg bag, comprising:
a support body having a first end adjacent a floor and a second end higher than the first end to form a ramp surface;
an opening in the ramp surface; and
a drain pan disposed within and connected to the drain pan.

2. The assembly of claim 1 wherein a drain plate having a plurality of slots covers the opening in the ramp surface.

3. The assembly of claim 1 wherein a stop member is positioned at the second end.

4. The assembly of claim 1 having at least one extension connected to the support body.
